(19) United States
(12) Patent Application Publication
(10) Pub. No.: US 2015/0321153 A1
(43) Pub. Date: Nov. 12, 2015

(54) FLUIDIZING NOZZLE OR BUBBLE CAP ASSEMBLY FOR AIR DISTRIBUTION GRID

(71) Applicant: Babcock & Wilcox Power Generation Group, Inc., Barberton, OH (US)

(72) Inventors: Mikhail MARYAMCHIK, Fairlawn, OH (US); Michael J. SZMANIA, Medina, OH (US); Stephen W. BORSANI, Wadsworth, OH (US); William C. HENSON, Massillon, OH (US); Donald L. WIETZKE, Carlsbad, CA (US); Joseph C. COMANITZ, Canton, OH (US)

(21) Appl. No.: 14/272,113

(22) Filed: May 7, 2014

(51) Int. Cl. B01F 3/04

(52) U.S. Cl. CPC B01F 3/0412

(57) ABSTRACT

A bubble cap assembly for an air distribution grid includes a stem having a top region and a bottom region, a bubble cap connected to the top region of the stem, a membrane having an opening, the bottom region of the stem communicating with the opening; a flange connected to the bottom region of the stem; at least one clamp for pressing the flange against the membrane, and a gasket squeezed between the flange and the membrane by the clamp to provide an air-tight connection between the flange and the membrane.

### FIELD AND BACKGROUND OF INVENTION

The present invention relates generally to fluid bed boilers, particularly improved fluidizing nozzle or bubble cap assemblies for air distribution grids in fluid bed boilers.

An air distribution grid is an important feature of a fluid bed boiler. Its purpose is to achieve a uniform air distribution across the bed plan area to fluidize the bed material in the furnace and to prevent backsifting of the bed material into the windbox. The most typical air distribution grid design is an array of bubble cap assemblies attached to a water-cooled membrane panel. Designs of bubble cap assemblies vary widely; two examples are shown in FIG. 1 and FIG. 2. A bubble cap assembly comprises bubble cap 1 and stem 2 that connects the cap 1 to an opening 3 in membrane 4 which is welded to water-cooled tubes 5.

During a start-up, if the boiler uses in-duct start-up burners, the air distribution grid is subjected to hot gases with a temperature that can exceed 1600° F. The bubble cap assemblies (typically made of stainless steel) have essentially the same temperature as these gases. Membrane 4, welded to tubes 5 and protected from direct contact with the hot gases by refractory 10 in the design shown in FIG. 2, would have a temperature close to the saturation water temperature in tubes 5, i.e. somewhere from 500° F. to 650° F., depending on the drum pressure. Membrane 4 is typically made of carbon steel. Welding stems 2, typically made of stainless steel, to the carbon steel membrane 4 creates dissimilar metal welds where the material with a higher thermal expansion coefficient (stainless steel) is at a much higher temperature than the material with a lower thermal expansion coefficient (carbon steel) thus resulting in high thermal stresses and a corresponding potential for cracking.

In order to avoid the weld cracking, the design shown in FIG. 2 features tack welding 15 of stem 2 to membrane 4, allowing their independent thermal expansions. Accommodating these expansions during start-up requires a gap 20 between the outside of the stem and the inside of the opening in the membrane 4. The stems' expansion at start-up and contraction at normal operation (when the stem temperature is somewhere from 300° F. to 500° F., depending on the temperature of the air flow through the stems at normal operation) results in a gap 25 between stem 2 and refractory 10. Therefore, the design shown in FIG. 2 is prone to air leakage through these gaps, with the leakage air bypassing the bubble caps 1. Lowering air flow through the bubble caps 1 leads to lowering the pressure drop across the bubble caps 1; this is conducive to bed material backsifting through the bubble caps 1 into the windbox. The backsifting can also result in plugging and erosion of the bubble caps 1.

Thus, there is a need for a system which avoids weld cracking. A system not prone to air leakage is also needed, so as to avoid the resultant lowering of pressure drop across the bubble caps, and reduce the potential for bed material backsifting as well as plugging and erosion of the bubble caps.

### SUMMARY OF INVENTION

The present invention reduces or eliminates backsifting of bed material through the bubble caps, as well as their plugging and erosion, by creating an air-tight connection between the bubble cap and the membrane while allowing their independent thermal expansions.

Accordingly, one aspect of the present invention is drawn to a system for improved air distribution in fluid bed boilers, namely a bubble cap assembly for an air distribution grid, comprising: a stem having a top region and a bottom region; a bubble cap connected to the top region of the stem; a membrane having an opening, the bottom region of the stem communicating with the opening; a flange connected to the bottom region of the stem; at least one clamp for pressing the flange against the membrane; and a gasket squeezed between the flange and the membrane by the clamp to provide an air-tight connection between the flange and the membrane.

Another aspect of the invention is drawn to a bubble cap assembly for an air distribution grid, comprising: a bifurcated stem having two top regions and a bottom region; a plurality of bubble caps, each bubble cap connected to a top region of the stem; a membrane having an opening, the bottom region of the stem communicating with the opening; a flange connected to the bottom region of the stem; at least one clamp for pressing the flange against the membrane; and a gasket squeezed between the flange and the membrane by the clamp to provide an air-tight connection between the flange and the membrane.

In some embodiments of the invention, the flange includes a recess, adapted to prevent the gasket from protruding from under the flange. A portion adjacent the recess also prevents the gasket from protruding to an inside area and potentially blocking the opening. The gasket provides an air-tight connection between the flange and the membrane.

The various features of novelty which characterize the invention are pointed out with particularity in the claims annexed to and forming part of this disclosure. For a better understanding of the present invention, and the operating advantages attained by its use, reference is made to the accompanying drawings and descriptive matter, forming a part of this disclosure, in which a preferred embodiment of the invention is illustrated.

### BRIEF DESCRIPTION OF THE DRAWINGS

In the accompanying drawings, forming a part of this specification, and in which like reference numbers are used to refer to the same or functionally similar elements:

FIG. 1 is a side elevation view of a prior art air distribution grid;

FIG. 2 is a side elevation view of another prior art air distribution grid;

FIG. 3 is a side elevation view showing the basic elements of the present invention;

FIG. 4 is a side elevation view showing an embodiment of the present invention in which stem 2a of FIG. 4 is cut just above membrane 4;

FIG. 5A is a side elevation view showing the clamp feature, as a wedge;

FIG. 5B is view of the clamp feature along line 5B-5B of FIG. 5A;

FIG. 6A is a side elevation view showing a bifurcated stem embodiment;

FIG. 6B is view of the clamp feature along line 6B-6B of FIG. 6A;

FIG. 7 is a side elevation view of the invention illustrating the relative orientations of the flange having apertures, threaded studs, and nuts for pressing the flange against the membrane;

FIG. 8 is a side elevation view of the invention illustrating use of a threaded extension below the flange which protrudes through the opening in the membrane, secured by a nut threaded onto the extension from beneath the membrane to press the assembly against the membrane; and

FIG. 9 is a side elevation view of another embodiment of the invention illustrating a flange in which no recess is provided.

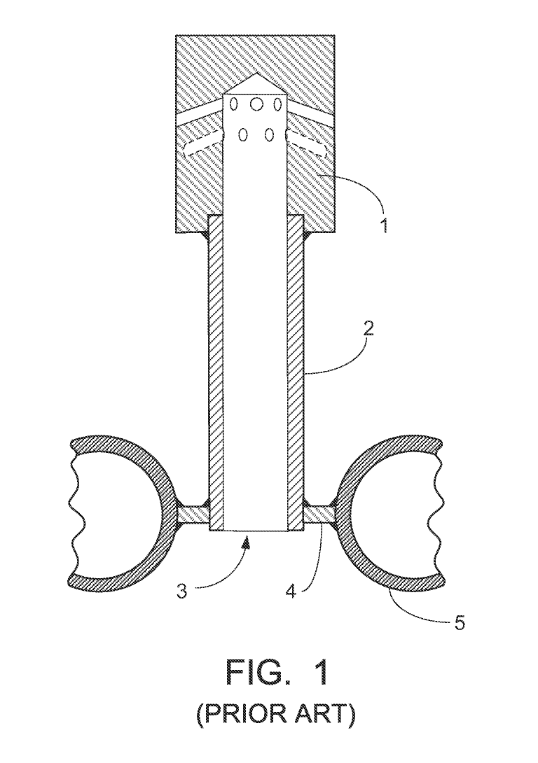

### DESCRIPTION OF THE PREFERRED EMBODIMENTS

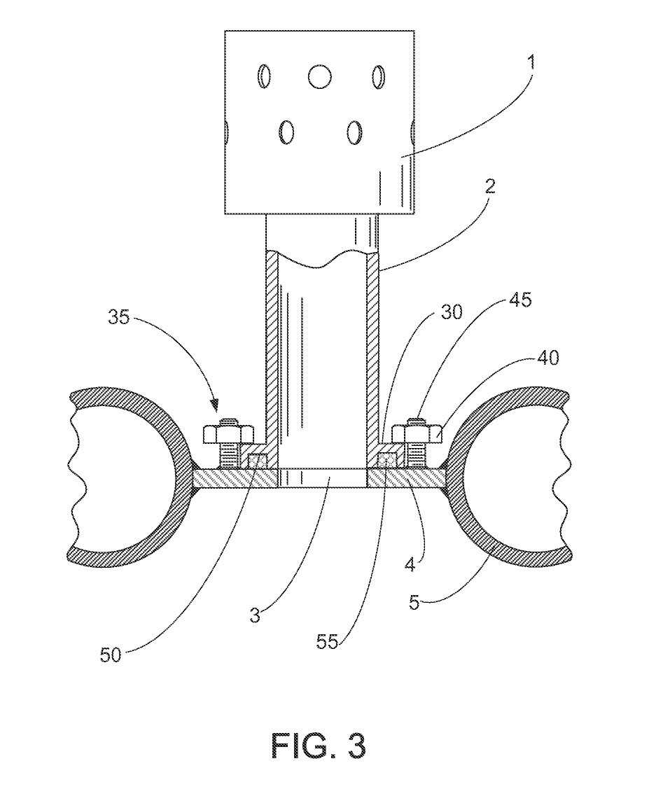

With reference to FIG. 3, one embodiment of the invention is shown therein, in which a bubble cap 1 is connected to a top region of stem 2. A bottom region of stem 2 is connected to opening 3 in membrane 4. Flange 30 is located at the bottom region of stem 2. Flange 30 is pressed against membrane 4 by clamps 35. In the embodiment shown in FIG. 3, the clamps 35 are made as nuts 40 screwed onto threaded studs 45 welded to membrane 4. In this embodiment, flange 30 features a recess 50 that keeps a gasket 55 from protruding from under flange 30. Gasket 55 is squeezed between flange 30 and membrane 4 providing an air-tight connection between them. A portion adjacent the recess 50 also prevents the gasket 55 from protruding to an inside area and potentially blocking opening 3.

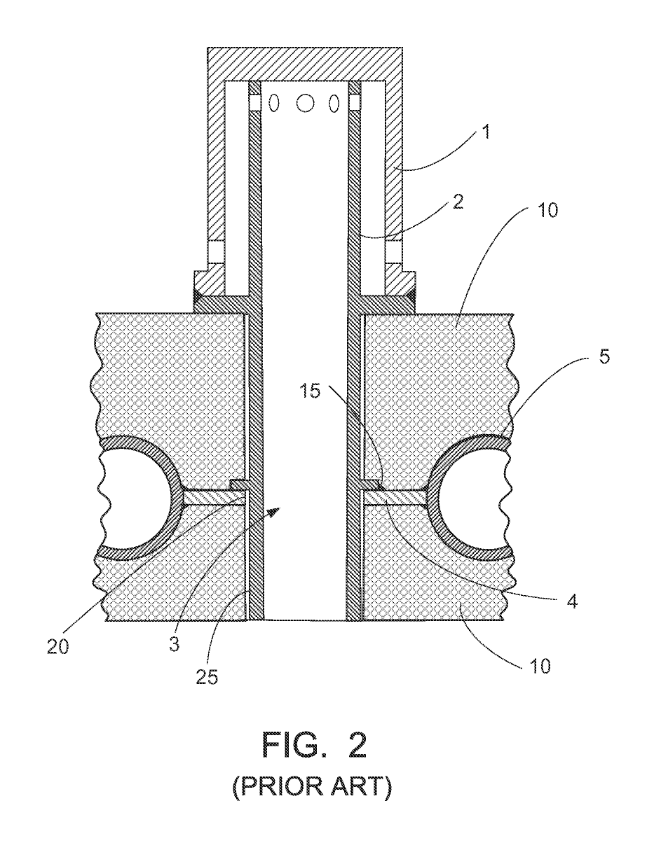

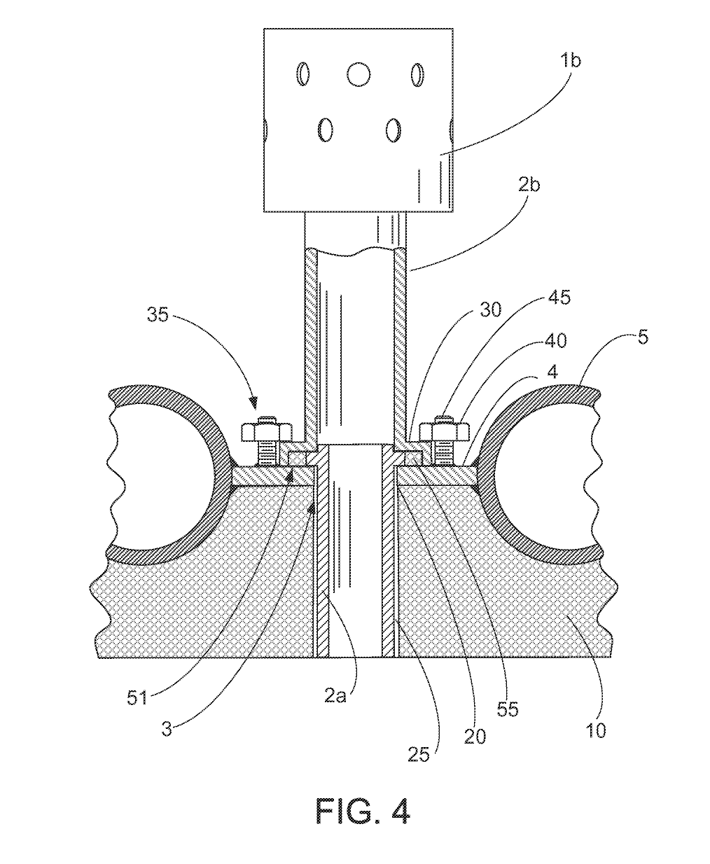

FIG. 4 shows another embodiment that can be used when retrofitting the design shown in FIG. 2 for eliminating air leakage around the bubble caps. Stem 2 (of the retrofitted design per FIG. 2) is cut just above membrane 4. New bubble cap 1b with stem 2b is installed. Stem 2b has a flange 30 with recess 51 that keeps gasket 55 from protruding to the outside of flange 30. The remaining piece 2a of the old stem 2 keeps gasket 55 from protruding to the inside of flange 30.

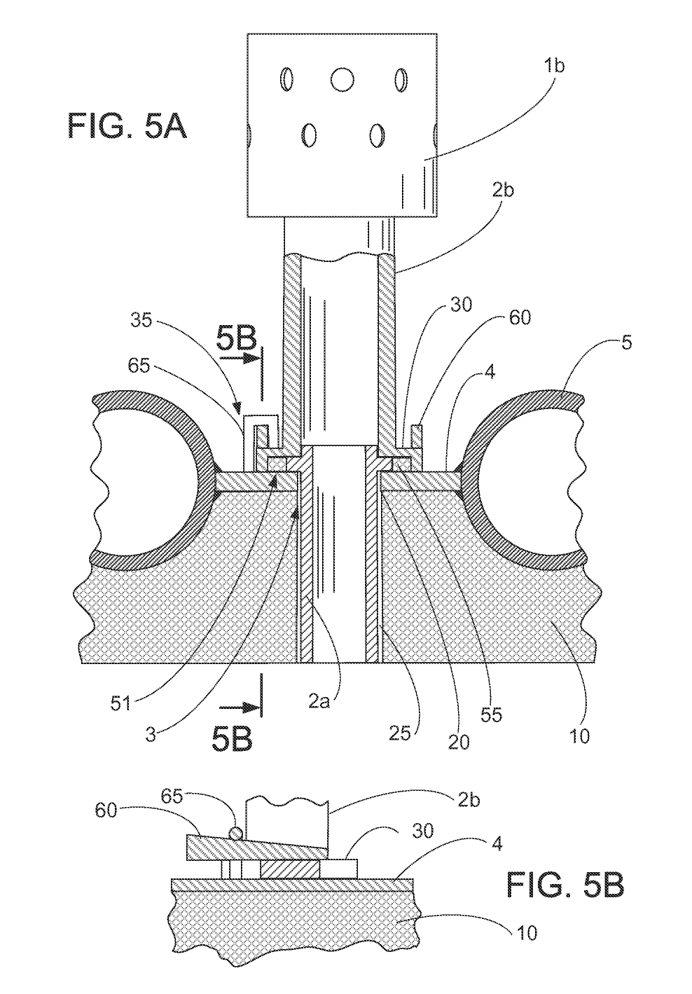

With reference to FIGS. 5A and 5B, an embodiment is shown in which a clamp 35 is made as a wedge 60 pressed between flange 30 and hook 65 welded to membrane 4. While wedge 60 is shown as being tapered, it may alternatively be provided without any taper.

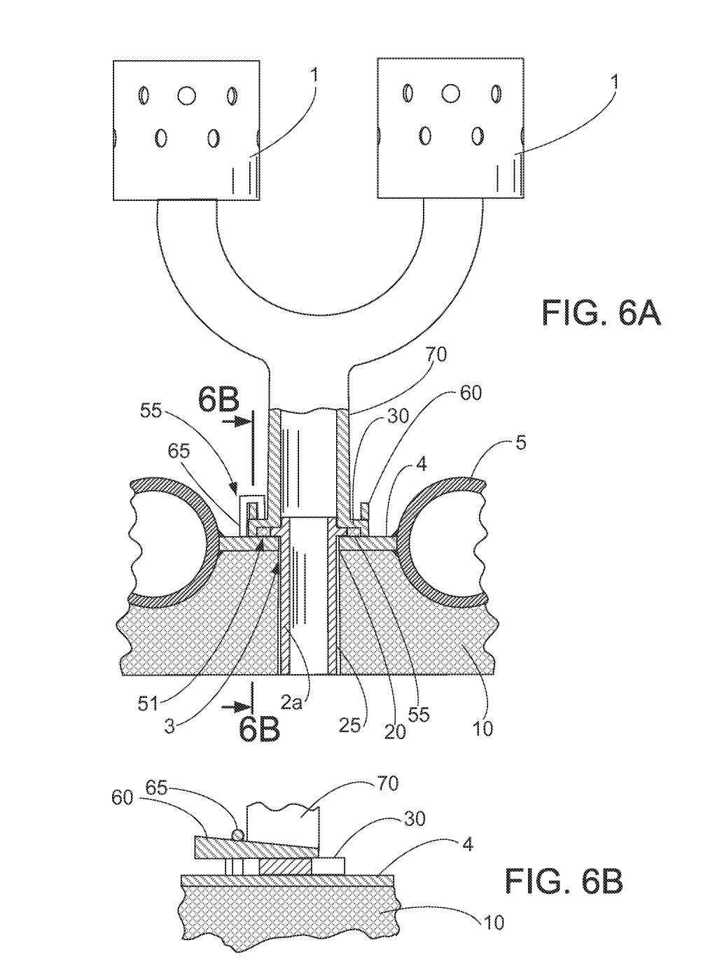

FIGS. 6A and 6B show an embodiment of the invention in which a bubble cap assembly comprises stem 70 with a bifurcated upper end and two bubble caps 1 (one on each top of the bifurcate). The lower end of stem 70 features flange 30 and is affixed to membrane 4 as described for the other embodiments.

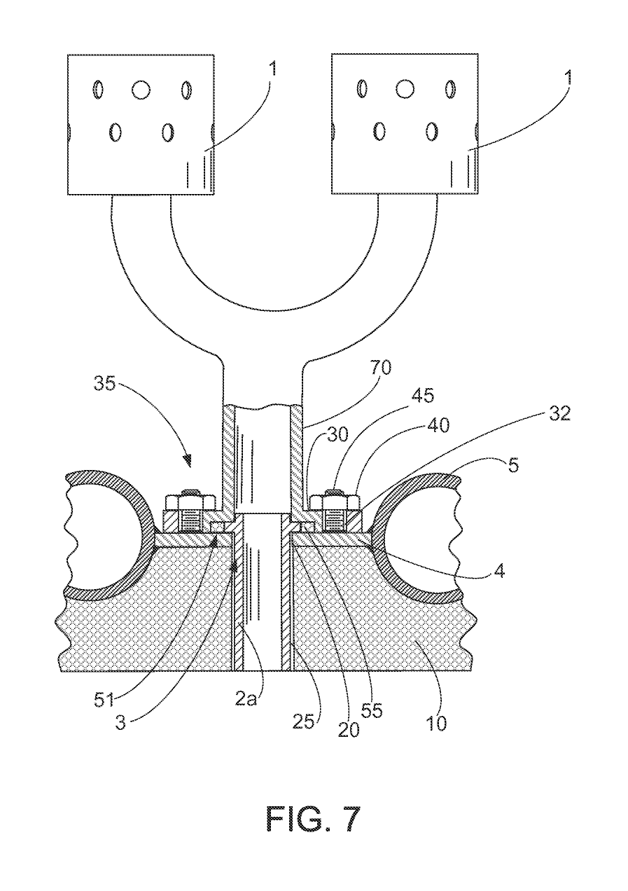

In another embodiment, shown in FIG. 7, flange 30 has apertures 32 that accommodate threaded studs 45. Nuts 40 screwed onto studs 45 press flange 30 to membrane 4.

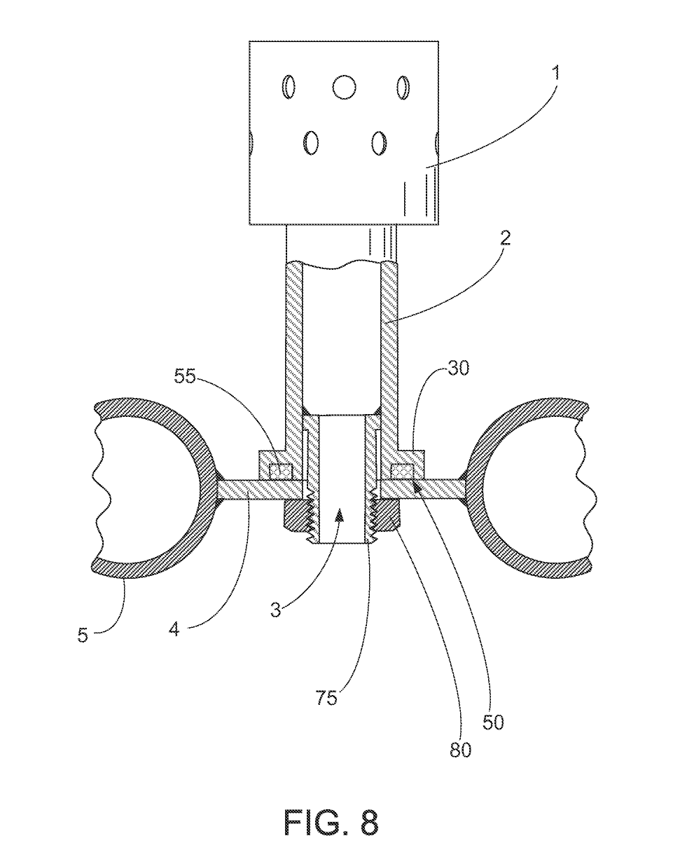

FIG. 8 shows an embodiment wherein flange 30 is pressed against membrane 4 by nut 80 screwed, from beneath the membrane 4, onto a threaded pipe or extension portion 75. Portion 75 may be either welded to stem 2 or alternatively provided as a threaded extension portion of stem 2 and protrudes through opening 3 in membrane 4.

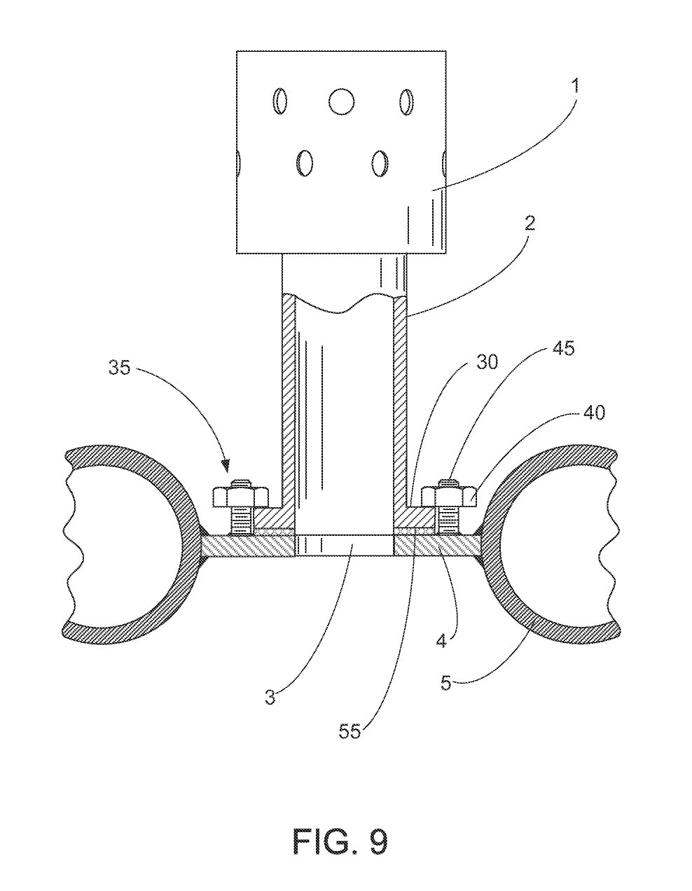

FIG. 9 shows an embodiment wherein the flange 30 is not provided with a recess for the gasket 55.

Among the many advantages provided by the present invention, it should be noted that a combination of thickness and width of membrane 4 allows maintaining its temperature during a start-up within acceptable limits without refractory protection.

While specific embodiments and/or details of the invention have been shown and described above to illustrate the application of the principles of the invention, it is understood that this invention may be embodied as more fully described in the claims, or as otherwise known by those skilled in the art, including any and all equivalents, without departing from such principles.

We claim:

1. A bubble cap assembly for an air distribution grid, comprising:
a stem having a top region and a bottom region;
a bubble cap connected to the top region of the stem;
a membrane having an opening, the bottom region of the stem communicating with the opening;
a flange connected to the bottom region of the stem;
at least one clamp for pressing the flange against the membrane; and
a gasket squeezed between the flange and the membrane by the clamp to provide an air-tight connection between the flange and the membrane.

2. The bubble cap assembly of claim 1, comprising a recess provided in the flange for preventing the gasket from protruding from under the flange.

3. The bubble cap assembly of claim 1, wherein the flange is pressed against the membrane by a plurality of clamps.

4. The bubble cap assembly of claim 3, wherein the plurality of clamps comprise nuts threadedly connected to threaded studs, the studs being welded to the membrane.

5. The bubble cap assembly of claim 2, comprising a portion adjacent the recess to keep the gasket from protruding to an inside area and potentially blocking the opening.

6. The bubble cap assembly of claim 1, wherein the clamp comprises a hook welded to the membrane and a wedge pressed between the flange and the hook.

7. The bubble cap assembly of claim 4, wherein the flange comprises apertures.

8. The bubble cap assembly of claim 7, wherein each of the threaded studs extends into one of the apertures, and a nut is threaded to each stud for pressing the flange against the membrane.

9. The bubble cap assembly of claim 1, wherein the stem has a threaded extension below the flange which protrudes through the opening in the membrane.

10. The bubble cap assembly of claim 9, comprising a nut threaded onto the extension from beneath the membrane to press the assembly against the membrane.

11. A bubble cap assembly for an air distribution grid, comprising:
a bifurcated stem having two top regions and a bottom region;
a plurality of bubble caps, each bubble cap connected to a top region of the stem;
a membrane having an opening, the bottom region of the stem communicating with the opening;
a flange connected to the bottom region of the stem;
at least one clamp for pressing the flange against the membrane; and
a gasket squeezed between the flange and the membrane by the clamp to provide an air-tight connection between the flange and the membrane.

12. The bubble cap assembly of claim 11, comprising a recess provided in the flange for preventing the gasket from protruding from under the flange.

13. The bubble cap assembly of claim 11, wherein the flange is pressed against the membrane by a plurality of clamps.

14. The bubble cap assembly of claim 13, wherein the plurality of clamps comprise nuts threadedly connected to threaded studs, the studs being welded to the membrane.

15. The bubble cap assembly of claim 12, comprising a portion adjacent the recess to keep the gasket from protruding to an inside area and potentially blocking the opening.

16. The bubble cap assembly of claim 11, wherein the clamp comprises a hook welded to the membrane and a wedge pressed between the flange and the hook.

17. The bubble cap assembly of claim 14, wherein the flange comprises apertures.

18. The bubble cap assembly of claim 17, wherein each of the threaded studs extends into one of the apertures, and a nut is threaded to each stud for pressing the flange against the membrane.

19. The bubble cap assembly of claim 11, wherein the stem has a threaded extension below the flange which protrudes through the opening in the membrane.

20. The bubble cap assembly of claim 19, comprising a nut threaded onto the extension from beneath the membrane to press the assembly against the membrane.
